(19) United States
(12) Patent Application Publication
(10) Pub. No.: US 2008/0148916 A1
(43) Pub. Date: Jun. 26, 2008

(54) Cutting device

(75) Inventors: Ayano Yamashita, Tokyo (JP); Naoki Ozawa, Tokyo (JP); Hiroyuki Urabe, Kawasaki-shi (JP); Emiko Nakasato, Kawasaki-shi (JP)

Correspondence Address: OLIFF & BERRIDGE, PLC, P.O. BOX 320850, ALEXANDRIA, VA, 22320-4850, US

(73) Assignee: CARL MANUFACTURING CO., LTD., TOKYO (JP)

(21) Appl. No.: 12/000,759

(22) Filed: Dec. 17, 2007

(30) Foreign Application Priority Data
Dec. 20, 2006 (JP) 2006-343625

(51) Int. Cl. B26D 1/18; B26D 5/00

(52) U.S. Cl. 83/471.2; 83/821; 83/743

(57) ABSTRACT

In a cutting device 1 for cutting a sheet material by moving a cutting tool along a rail provided at a template, the cutting tool is configured such that a cutting blade and guide portions engaged with the rail are provided on a disc face of a rotary disc, and the rotary disc is rotatably mounted to a grasping portion. When the guide portion is engaged with the rail, the rotary disc is naturally rotated while being guided by the curved rail, and the cutting blade provided at the rotary disc is naturally oriented in the same direction as the rail.

### BACKGROUND OF THE INVENTION

1. Field of the Invention

The present invention relates to a cutting device for cutting a sheet in a curve state by placing a template on a sheet such as a paper sheet or a cloth sheet and by moving a cutting tool along a guide rail on the template and particularly to a cutting device which does not require fine manual operation but can cut a beautiful and smooth curve.

2. Description of the Related Art

Various devices have been proposed for cutting a sheet material in a curved state by moving a cutting tool along a guide rail on a template.

For example, Patent Document 1 discloses a cutting system for cutting a sheet in a curved state by moving a cutting tool provided with a guide portion and a cutting blade on its end face along a curved groove of a template placed on the sheet. This system cuts a sheet using the cutting blade on the end face of the cutting tool by moving the guide portion provided on the end face of the cutting tool in sliding contact with the groove in the template.

Patent Document 2 discloses a cutting system in which a cutting tool is mounted on an axis of an open portion of a ring-shaped frame and the cutting tool is moved with a peripheral edge of the frame in sliding contact with an opening edge portion of a template so as to cut a sheet material under the template by a cutting blade provided at a lower end of the cutting tool.

Patent Document 1: PCT Japanese Translation Patent Publication No. 2004-506521

Patent Document 2: U.S. Patent Publication No. 6,722,051B2

However, in the system disclosed in Patent Document 1, the direction of the cutting tool should be adjusted during movement so that the cutting blade travels along the curve of the groove when the cutting tool is moved along the curved groove of the template, which requires fine manual operation at a handle portion.

In the system disclosed in patent Document 2, when the peripheral edge of the frame is moved in sliding contact with the opening edge portion of the template, the cutting tool is rotated around the distal end of the cutting blade, and the cutting blade is oriented in a direction different from the moving direction. This causes damage to the cutting edge of the cutting blade or hinders cutting in a smooth curve, which are disadvantageous.

### SUMMARY OF THE INVENTION

The present invention has been made in light of the above problem, and it is an object of the present invention to provide a cutting device which can cut a beautiful and smooth curve without requiring fine manual operation.

In order to achieve the above object, a cutting device according to the present invention is a cutting device for cutting a sheet material arranged under a template by moving a cutting tool along a rail provided at the template, and the cutting tool comprises a cutting blade for cutting the sheet material and a guide portion engaged with the rail on a disc face of a rotary disc and the rotary disc is rotatably mounted to a grasping portion.

In this case, the rail is in a curved state, and the guide portion has an inner guide portion in sliding contact with an inner side wall face of the rail and an outer guide portion in sliding contact with an outer wall face, and a rail width may be set so that the inner guide portion and the outer guide portion are brought into sliding contact with the rail all the time.

The rail has a projecting section and the inner guide portion is brought into sliding contact with the inner wall face of the rail at first and second contact points located on a straight line in parallel with the direction of the cutting blade, while the outer guide portion may be brought into sliding contact with the outer wall face of the rail at a third contact point located at the same distance from the first and second contact points.

The cutting blade is fixed to a cutting-blade holder, and the cutting-blade holder may be detachably provided by being fitted in a fitting recess portion provided on the rotary disc.

On the rotary disc, a plurality of the fitting recess portions may be provided to be separated by different distances from the guide portion.

The grasping portion is cap-shaped and covers the rotary disc, and a flange portion may be provided on its open peripheral end edge.

In a cutting device according to claim 1, a cutting tool moved along a rail of a template is configured such that a cutting blade and a guide portion are provided at a rotary disc and the rotary disc is rotatably mounted at a grasping portion, and when the guide portion is engaged with the rail, the rotary disc is automatically rotated while being guided by the curved rail, and the cutting blade provided at the rotary disc can be naturally oriented in a direction of the rail. Therefore, there is no need to rotate the cutting tool by manual operation in order to orient the cutting blade in a direction along the rail, and a beautiful and smooth curved figure can be easily cut.

The “rail” in this case refers to a track of the guide portion and it may be a groove state or a projecting stripe.

In a cutting device according to claim 2, the guide portion comprises an inner guide portion in sliding contact with a wall face inside the rail and an outer guide portion in sliding contact with the outside wall face, and the guide portion is in sliding contact with the wall faces on both sides of the rail all the time. Thus, the guide portion is not jounced in the rail-width direction but can cut an accurate curve according to the template. As a result, when a closed figure such as a perfect circle and an oval is to be cut, the end point of the cutting line can be accurately matched with the start point.

In a cutting device according to claim 3, the rail in the invention in claim 2 is formed with a projecting section, and the inner guide portion is brought into sliding contact with the inner wall face of the rail at two contact points located on a straight line in parallel with the direction of the cutting blade, while the outer guide option is in sliding contact with a contact point located at the same distance from the contact points. Thus, the guide portion can be brought into sliding contact with the curve of the rail in a stable state. Therefore, since the parallel state between the disc face of the rotary disc and the sheet material is maintained, rotation of the cutting blade when the rotary disc is rotated can be stabilized, and an incident angle of the cutting blade with the sheet material can be kept constant. By this arrangement, a smooth curved figure can be cut.

In a cutting device according to claim 4, the cutting blade is fixed to a cutting-blade holder, and this cutting-blade holder is fitted in a fitting recess portion provided at the rotary disc so that the cutting blade can be removed. By this arrangement, replacement becomes easy when the cutting blade is broken. Also, it becomes possible to replace and cut as appropriate by preparing various cutting-blade holders in which different types of cutting blades are fixed.

In a cutting device according to claim 5, since a plurality of the fitting recess portions separated by different distances from the guide portion are provided at the rotary disc, by selecting the fitting recess portion and mounting the cutting-blade holder as appropriate, a position of a curve to be cut can be changed. By this arrangement, when a template for cutting a circle is used, for example, a plurality of types of circular figures with different radiuses can be cut with a single template.

In a cutting device according to claim 6, the grasping portion is constructed in a cap shape that covers the rotary disc and a flange portion is provided at its open peripheral end edge so that a finger about to grasp the cutting tool can be stopped at the flange portion. By this arrangement, a possibility of contact between the finger and the cutting blade is reduced, and safety can be improved.

### BRIEF DESCRIPTION OF THE DRAWINGS

FIG. 1 is a perspective view illustrating a cutting device according to an embodiment of the present invention;

FIG. 2 is a perspective view illustrating a template of the cutting device;

FIG. 3 is a sectional view of the template;

FIG. 4 is a front view illustrating a disc face of a rotary disc in a cutting tool of the cutting device;

FIG. 5 is an explanatory view illustrating a relationship between a guide portion of the rotary disc and a rail;

FIG. 6 is a perspective view illustrating the cutting tool;

FIG. 7 is a sectional view of the cutting tool;

FIG. 8 is a perspective view illustrating a mounting state of a grasping portion of the cutting tool;

FIG. 9 is an explanatory view illustrating the rail and a cutting line when a perfect circle is cut out;

FIG. 10 is an explanatory view illustrating the rail and the cutting line when an oval is cut out;

FIG. 11 is a sectional view illustrating a variation of the rail and the guide portion of the embodiment;

FIG. 12 is a front view illustrating the guide portion;

FIG. 13 shows a variation of the embodiment and a front view illustrating the disc face of the cutting tool in which a plurality of recess portions to have a rotary-blade holder fitted in the rotary disc are provided;

FIG. 14 shows a variation of the embodiment and is a front view illustrating the disc face of the cutting tool configured so that an inner guide portion is in sliding contact with an inner wall face of the rail at a single point;

FIG. 15 is an explanatory view illustrating a variation of the rail of the embodiment;

FIG. 16 shows a variation of the embodiment and is a front view illustrating the disc face of the cutting tool in which the cutting blade is provided adjacent to an outer guide portion; and

FIG. 17 is a front view illustrating a variation of the template in the embodiment.

### DETAILED DESCRIPTION OF THE PREFERRED EMBODIMENTS

A preferred embodiment of the present invention will be described based on the attached drawings. The embodiment is not limited to the following mode but another mode can be put into practice if it can solve the problem of the present invention.

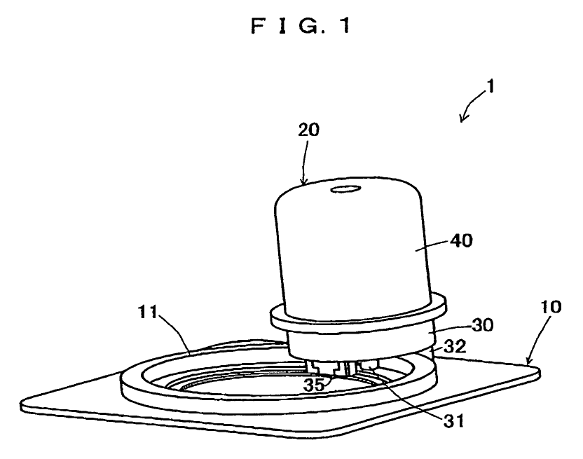

FIG. 1 is a perspective view illustrating a cutting device 1 according to the embodiment of the present invention.

The cutting device 1 cuts a sheet material in a curved state by moving a cutting tool 20 along a curved rail 11 provided at a template 10 and comprises the template 10 and the cutting tool 20.

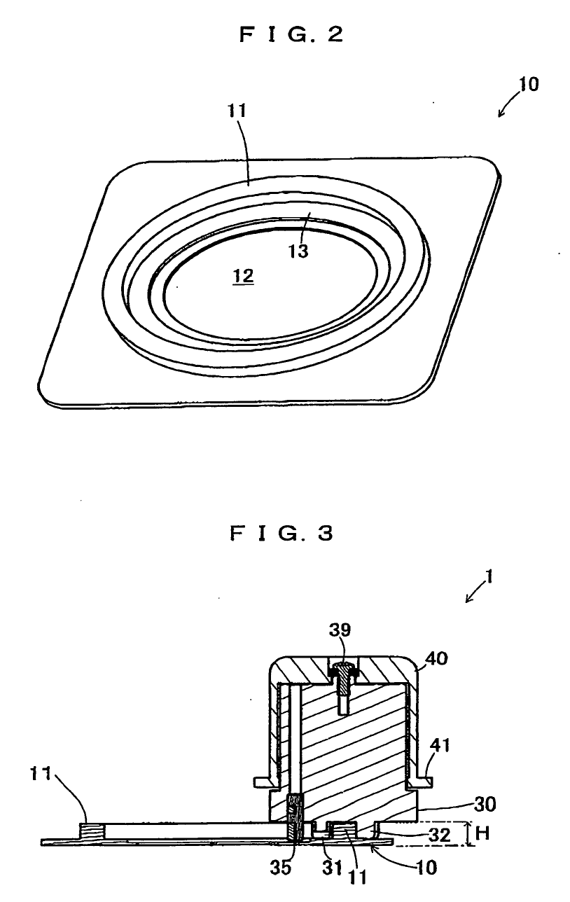

First, configuration of the template 10 will be described. The template 10 has, as shown in FIG. 2, an open portion 12 provided at a center of a plane member and a rail 11 around that.

The open portion 12 of the template is formed conforming to a shape to be cut. A stepped portion 13 with the same width is provided around the open portion 12, and the rail 11 in a shape corresponding to the open portion 12 is provided around it.

This rail 11 is a track for guiding movement of the cutting tool 20 and is formed with a projecting section as shown in FIG. 3 so as to engage guide portions 31, 32 of the cutting tool 20, which will be described later. The width of the rail 11 is formed according to the shapes of the guide portions 31, 32 so that the guide portions 31, 32 of the cutting tool 20 are in sliding contact with the wall faces on both inner and outer sides of the rail 11 all the time.

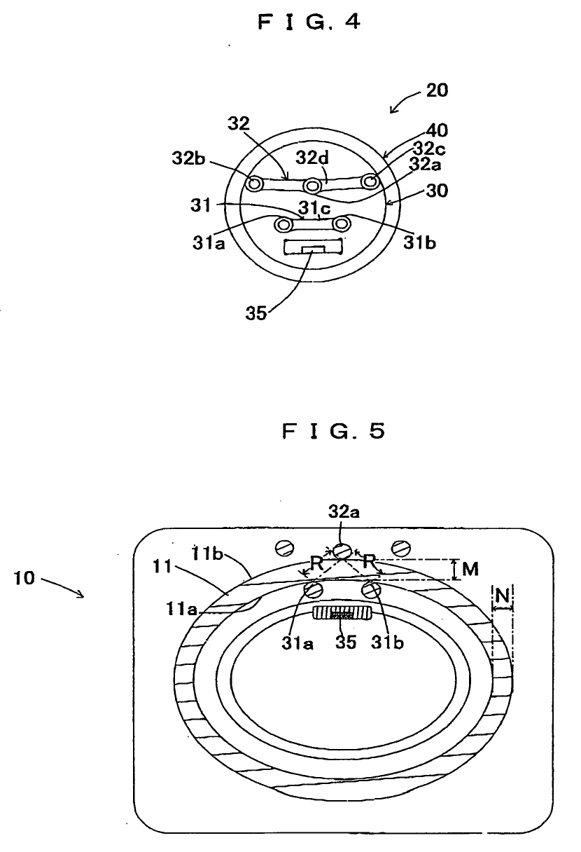

That is, the guide portions 31, 32 of the cutting tool 20 are configured by the inner guide portion 31 and the outer guide portion 32 formed on a disc face of a rotary disc 30, which will be described later, as shown in FIG. 4. A rail width M at a portion of the rail 11 with a small curvature is set large and a rail width N at a portion of the rail 11 with a large curvature is set small so that two contact points 31a, 31b constituting both end portions of the inner guide portion 31 are in sliding contact with an inner wall face 11a of the rail 11 all the time, as shown in FIG. 5, and a contact point 32a constituting a center part of the outer guide portion 32 is in sliding contact with an outer wall face 11b all the time.

The rail 11 uses a material different from that of the guide portions 31, 32 so as to improve sliding when being brought into sliding contact with the guide portions 31, 32.

In this case, a material such as ABS (acrylonitrile butadiene styrene resin), PS (polystyrene), or PC (polycarbonate), which can be made transparent is preferably used for the rail 11, while POM (polyacetal) or PA (6-nylon, 66-nylon) is preferably used for the guide portions 31, 32.

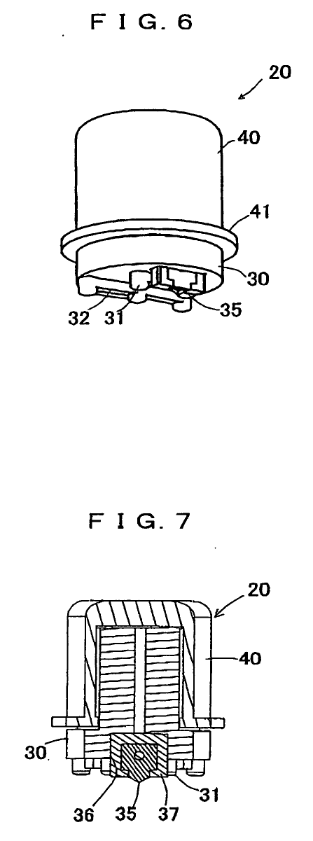

Next, configuration of the cutting tool 20 will be described. The cutting tool 20 has, as shown in FIG. 6, a cap-shaped grasping portion 40 rotatably mounted to the rotary disc 30 having a cylindrical shape.

On the disc face of the rotary disc 30 on the side not mounted to the grasping portion 40, the guide portions 31, 32 and the cutting blade 35 are mounted. That is, the guide portions 31, 32 guide movement of the cutting tool 20 by engagement with the rail 11 of the template 10 and include the inner guide portion 31 in sliding contact with the inner wall face 11a of the rail 11 and the outer guide portion 31 in sliding contact with the outer wall face 11b.

The inner guide portion 31 is, as shown in FIG. 4, located on a straight line in parallel with the direction of the cutting blade 35 and in a shape connecting projection portions provided on both ends (that is, contact points 31a, 31b) by a low wall 31c. The projection portions are portions to be first and second contact points 31a, 31b in sliding contact with the inner wall face 11a of the rail 11 and formed into a cylindrical shape in order to improve sliding with the wall face of the rail 11. The tip end of the projection portion is processed into a spherical shape in order to improve sliding with the bottom face of the rail 11 (that is, a template face).

The outer guide portion 32 is formed in parallel with the inner guide portion 31. The outer guide portion 32 is provided on the side opposite the cutting blade 35 and is made up of three projection portions 32a, 32b, 32c connected by a low wall 32d. The projection portion 32a located at the center of the outer guide member 32 is located at the same distance R from the first and second contact points 31a, 31b of the inner guide portion 31 (See FIG. 5). The curved face inside the projection portion is a portion to be the third contact portion 32a in sliding contact with the outer wall face 11b of the rail 11. The third contact point 32a also has the columnar distal end portion in a shape obtained by spherical processing in order to improve sliding with the rail 11 similarly to the first and second contact points.

In the inner guide portion 31 and the outer guide portion 32, the low walls 31c, 32d connecting the projection portions are provided for regulation so that the rail 11 of the template 10 is not displaced from between the inner guide portion 31 and the outer guide portion 32.

The cutting blade 35 is provided in parallel with the inner and outer guide portions 31, 32. That is, as shown in FIG. 7, a recess portion 36 is provided at the rotary disc 30, and in the recess portion 36, a cutting-blade holder 37, to which the cutting blade 35 is fixed, is fitted. The recess portion 36 is designed so that the direction of the cutting blade 35 is in parallel with the inner and outer guide portions 31, 32 by fitting of the cutting-blade holder 37. The stepped portion 13 provided at the template 10 prevents contact with the rotary-blade holder 37.

A height H of the cutting blade 35 with respect to the rotary disc 30 is designed so that the cutting blade 35 is located below a lower face 15 of the template 10 (that is, the face on the side in contact with the sheet) when the guide portion of the rotary disc 30 is engaged with the rail 11 of the template 10 (See FIG. 3).

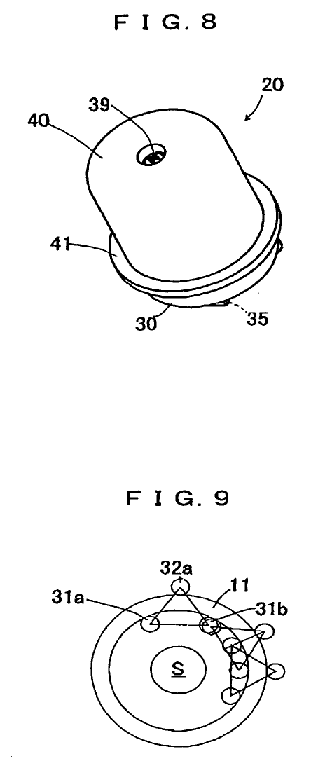

On the disc face on the side opposite the side where the guide members 31, 32 and the cutting blade 35 are mounted, a rotary shaft 39 for rotatably mounting a grasping portion, which will be described later, is mounted at the center. Through the rotary shaft 39, the cap-shaped grasping portion 40 is mounted (See FIGS. 3 and 8).

The grasping portion 40 is a portion grasped when the cutting tool 20 is moved along the rail 11 of the template 10 and is a cylindrical body with a lid and without a bottom formed conforming to the shape of the rotary disc 30. A finger stopper 41 in the flange shape is provided at an open end portion of the cylindrical body in order to prevent a finger grasping the cutting tool 20 from reaching the position of the cutting blade 35 of the rotary disc 30.

First, a mat or the like is placed on a work bench and a sheet material such as a paper sheet and a cloth sheet is placed thereon. The template 10 is mounted at a position to be cut on the sheet material.

The cutting tool 20 is moved while the guide portions 31, 32 of the cutting tool 20 are engaged with the rail 11 of the template 10. By this operation, the sheet material is cut out in the shape corresponding to the rail 11.

In this case, since the rotary disc 30 of the cutting tool 20 is guided by the guide portions 31, 32 and the rail 11 is rotated in a curving direction, the direction of the cutting blade 35 for cutting the sheet material is automatically rotated in the same direction as that of the rail 11. As a result, there is no need to grasp the grasping portion 40 again along the direction of the cutting blade 35 for rotation any more, and the sheet material can be easily cut in the curved shape.

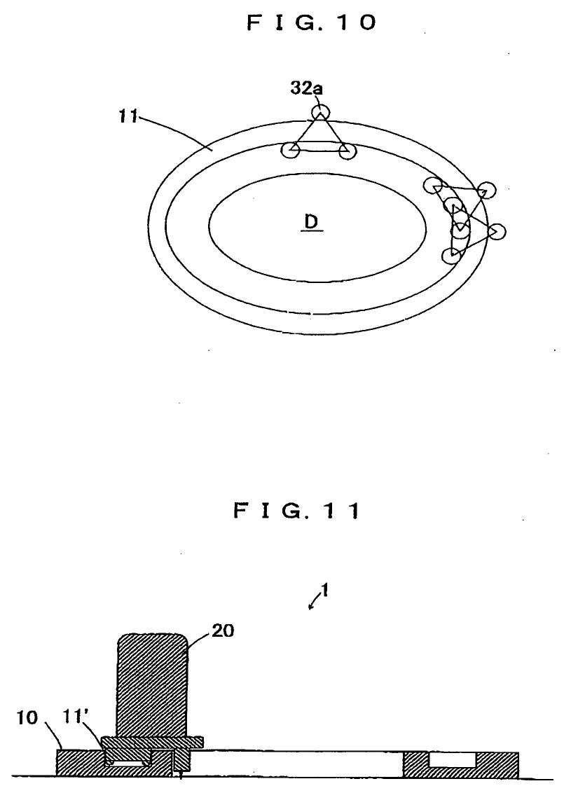

In the rotary disc 30 shown in FIG. 4, if the first, second and third contact points 31a, 31b, 32a are designed to be arranged on a regular triangle, a perfect circle S can be cut by using the rail 11 in the shape shown in FIG. 9. Also, by using the rail in the shape shown in FIG. 10, an oval D can be cut.

Other than the perfect circle and oval, a template which can cut a figure such as a flower, star, or heart, or a character such a letter of the an alphabet, hiragana character or katakana character can be used and a complicated figure can be cut out by combining a plurality of templates.

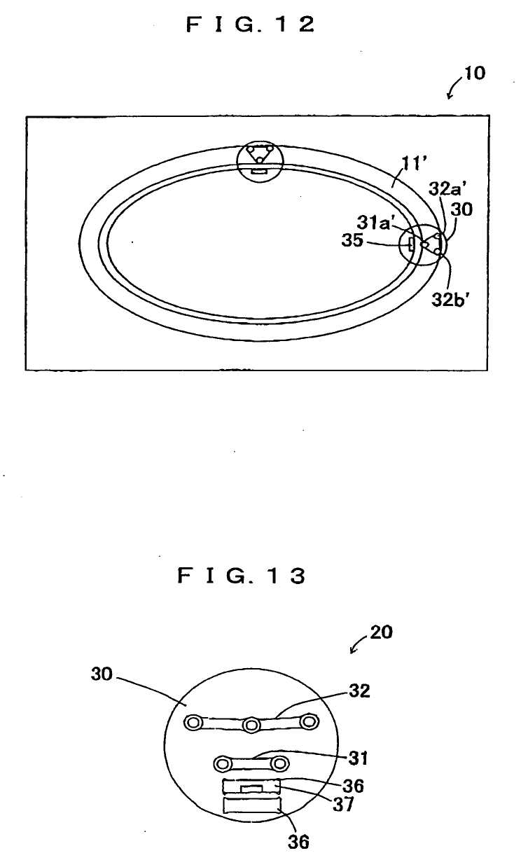

In this embodiment, the rail 11 of the template 10 is configured in the projecting state, but as shown in FIG. 1, a rail 11′ may be configured as a recess-type groove. In this case, as shown in FIG. 12, by configuring the outer guide portion including two projection portions 32a′, 32b′ located on a parallel line of the cutting blade 35, sliding contact can be realized with two locations on the outer wall face of the groove. A projection portion 31a′ may be configured as an inner guide portion in sliding contact with the inner wall face of the groove at the same distance from the two projection portions 32a′, 32b′.

The grasping portion 40 of the cutting tool 20 may be formed in a different shape, or the flange portion does not have to be provided at the open peripheral end edge.

As shown in FIG. 13, the recess portion 36 to which the cutting-blade holder 37 is fitted may be provided in plural on the rotary disc 30. In this case, each recess portion 36 is provided in parallel with the guide portions 31, 32. By selectively mounting the cutting-blade holder 37 on the recess portions 36, it becomes possible to form a plurality of types of circles with different radiuses using the single rail 11 when the rail 11 of the template 10 is a circle, for example.

Alternatively, the cutting blade 35 may be directly embedded in the rotary disc 30, or the rotary disc 30 may be configured so as to be detachable with respect to the grasping portion 40.

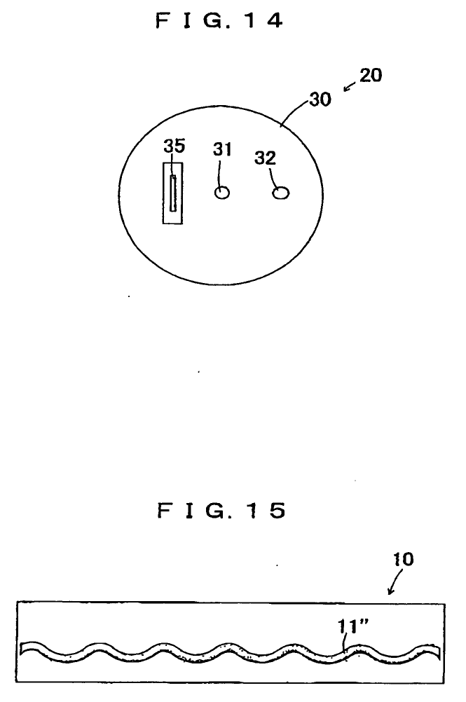

The rail 11 of the template 10 may be configured with the same width, or the inner guide portion 31 of the cutting tool 20 may be configured to be in sliding contact with the inner wall face of the rail 11 at a single point as shown in FIG. 14. By using the cutting tool 20 as above, the sheet can be cut into a wave shape using a wave-shaped rail 11″ of the template 10 shown in FIG. 15, for example.

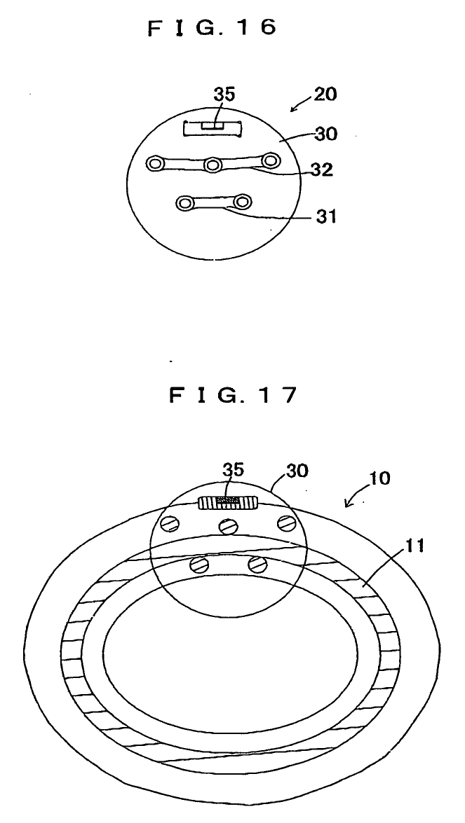

As shown in FIG. 16, the cutting blade 35 of the rotary disc 30 may be provided adjacent to the outer guide portion 32. By this arrangement, as shown in FIG. 17, by using the template 10 which can be used to perform cutting outside of the rail 11, cutting along the template peripheral edge portion outside the rail 11 becomes possible, and cutting of a larger figure also becomes possible.

Moreover, in order to reduce friction resistance between the guide portions 31, 32 of the cutting tool 20 and the rail 11 of the template 10, the contact points 31a, 31b, 32a of the guide options 31, 32 may be configured by a rotatable shaft or bearing.

1. A cutting device for cutting a sheet material arranged below a template by moving a cutting tool along a rail provided at the template, characterized in that
said cutting tool is configured such that a cutting blade for cutting said sheet material and guide portions engaged with said rail are provided on a disc face of a rotary disc, and the rotary disc is rotatably mounted on a grasping portion.

2. The cutting device according to claim 1, wherein
said rail has a curved shape;
said guide portions include an inner guide portion in sliding contact with an inner wall face of said rail and an outer guide portion in sliding contact with an outer wall face; and
a rail width is designed so that said inner guide portion and the outer guide portion are in sliding contact with said rail all the time.

3. The cutting device according to claim 2, wherein
said rail has a projecting section;
said inner guide portion is brought into sliding contact with an inner wall face of said rail at first and second contact points located on a straight line in parallel with the direction of the cutting blade, and said outer guide portion is brought into sliding contact with an outer wall face of said rail at a third contact point located at the same distance from said first and second contact points.

4. The cutting device according to claim 1, wherein said cutting blade is fixed to a cutting-blade holder and detachably provided by fitting the cutting-blade holder in a fitting recess portion provided at said rotary disc.

5. The cutting device according to claim 4, wherein said fitting recess portions separated from said guide portions by different distances are provided in plural on said rotary disc.

6. The cutting device according to claim 1, wherein said grasping portion has a cap shape and covers the rotary disc, and a flange portion is provided on its open peripheral end edge.

7. The cutting device according to claim 2, wherein said cutting blade is fixed to a cutting-blade holder and detachably provided by fitting the cutting-blade holder in a fitting recess portion provided at said rotary disc.

8. The cutting device according to claim 3, wherein said cutting blade is fixed to a cutting-blade holder and detachably provided by fitting the cutting-blade holder in a fitting recess portion provided at said rotary disc.

9. The cutting device according to claim 7, wherein said fitting recess portions separated from said guide portions by different distances are provided in plural on said rotary disc.

10. The cutting device according to claim 8, wherein said fitting recess portions separated from said guide portions by different distances are provided in plural on said rotary disc.

11. The cutting device according to claim 2, wherein said grasping portion has a cap shape and covers the rotary disc, and a flange portion is provided on its open peripheral end edge.

12. The cutting device according to claim 3, wherein said grasping portion has a cap shape and covers the rotary disc, and a flange portion is provided on its open peripheral end edge.

13. The cutting device according to claim 4, wherein said grasping portion has a cap shape and covers the rotary disc, and a flange portion is provided on its open peripheral end edge.

14. The cutting device according to claim 7, wherein said grasping portion has a cap shape and covers the rotary disc, and a flange portion is provided on its open peripheral end edge.

15. The cutting device according to claim 8, wherein said grasping portion has a cap shape and covers the rotary disc, and a flange portion is provided on its open peripheral end edge.

16. The cutting device according to claim 5, wherein said grasping portion has a cap shape and covers the rotary disc, and a flange portion is provided on its open peripheral end edge.

17. The cutting device according to claim 9, wherein said grasping portion has a cap shape and covers the rotary disc, and a flange portion is provided on its open peripheral end edge.

18. The cutting device according to claim 10, wherein said grasping portion has a cap shape and covers the rotary disc, and a flange portion is provided on its open peripheral end edge.
